(19) United States
(12) Patent Application Publication
(10) Pub. No.: US 2017/0256183 A1
(43) Pub. Date: Sep. 7, 2017

(54) MAGNETIC CONNECTOR FOR ANATOMIC MODELS AND METHODS OF MAKING AND USING

(71) Applicant: Michael Itagaki, Bellevue, WA (US)

(72) Inventor: Michael Itagaki, Bellevue, WA (US)

(21) Appl. No.: 15/449,629

(22) Filed: Mar. 3, 2017

Related U.S. Application Data
(60) Provisional application No. 62/303,847, filed on Mar. 4, 2016.

(51) Int. Cl. G09B 23/34; G09B 23/30

(52) U.S. Cl. CPC G09B 23/34; G09B 23/30

(57) ABSTRACT

An anatomic model includes a first part with a first connector element disposed at one end of the first part, the first connector element including at least one tooth, at least one indented region, and magnets disposed within the tooth or adjacent the indented region; and a second part with a second connector element disposed at one end of the second part, the second connector element including at least one tooth, at least one indented region, and disposed within the tooth or adjacent the indented region. The indented regions receive the teeth to interlock the first and second connector elements. The magnets of the first and second connector elements are arranged to hold the first and second connector elements together when interlocked until manually released.

### CROSS-REFERENCE TO RELATED APPLICATIONS

This application claims the benefit under 35 U.S.C. §119(e) of U.S. Provisional Patent Application Ser. No. 62/303,847, filed Mar. 4, 2016, which is incorporated herein by reference.

### FIELD

The present invention is directed to the area of magnetic connectors. The present invention is also directed to magnetic connectors for use with anatomic models.

### BACKGROUND

3-D printing, also called additive manufacturing, is a technology that is at least 30 years old, but has only recently been used for medically related applications. One use is converting anatomic data acquired from a diagnostic imaging scan, such as computed tomography (CT), magnetic residence imaging (MM), or ultrasound, and manufacturing a physical replica on a 3-D printer. These physical anatomic replicas, created from real patient scan data, have many new potential applications, including use for surgical planning, custom medical device development, and medical education.

There have been challenges using current technology for creating anatomic replicas. Such challenges include model size, finishing, and access for medical devices. Affordable 3-D printers typically have very limited build volumes. Anatomic models, being from a human body, can be quite large when printed at full size. 3-D printers exist that can manufacture large parts, but they are typically very expensive. Manufacturing smaller parts is cheaper.

Anatomic structures are often irregular, and in many cases hollow such as with blood vessels. Getting access to all parts of the model, including hard to reach internal surfaces, can be quite difficult. This can make creation of a good surface finish very difficult, particularly for large and hollow anatomic structures. In addition, when used for training or testing of medical devices, anatomic models should allow medical devices to be deployed or retrieved easily.

### BRIEF SUMMARY

One embodiment is an anatomic model including a first part with a first connector element disposed at one end of the first part, the first connector element including at least one tooth, at least one indented region, and magnets disposed within the tooth or adjacent the indented region; and a second part with a second connector element disposed at one end of the second part, the second connector element including at least one tooth, at least one indented region, and disposed within the tooth or adjacent the indented region. The at least one indented region of the second connector element receives the at least one tooth of the first connector element and the at least one indented region of the first connector element receives the at least one tooth of the second connector element to interlock the first and second connector elements. The magnets of the first and second connector elements are arranged to hold the first and second connector elements together when interlocked until manually released.

In at least some embodiments, the first connector element includes a plurality of the teeth and a plurality of the indented regions and the second connector element includes a plurality of the teeth and a plurality of the indented regions. In at least some embodiments, the magnets of the first connector element are disposed within the teeth of the first connector element. In at least some embodiments, the magnets of the second connector element are disposed adjacent the indented regions of the second connector element. In at least some embodiments, each of the teeth of the first and second connector elements has a longer outer circumferential length than inner circumferential length to resist translational or radial movement of the first and second connector elements relative to each other when engaged.

In at least some embodiments, the anatomic model represents a portion of a vascular system and contains a lumen corresponding to a vascular lumen. In at least some embodiments, each of the first and second connectors defines an inner lumen extending therethrough. In at least some embodiments, the inner lumens of the first and second connectors have a shape corresponding to the vascular lumen at a position where the first and second connector elements are placed in the anatomic model.

In at least some embodiments, the first and second connector elements are integrally formed with the first and second parts, respectively. In at least some embodiments, the first and second connector elements, other than the magnets, are formed of a same material as a remainder of the first and second parts. In at least some embodiments, each of the magnets is disposed in a well within the respective first or second connector element and covered with a polymeric material. In at least some embodiments, the first part and the first connector element, except for the magnets, are made of a first material and the second part and the second connector element are made of a second material different from the first material.

Another embodiment is a connector including a first connector element having at least one tooth, at least one indented region, and magnets disposed within the tooth or adjacent the indented region; and a second connector element having at least one tooth, at least one indented region, and disposed within the tooth or adjacent the indented region. The at least one indented region of the second connector element receives the at least one tooth of the first connector element and the at least one indented region of the first connector element receives the at least one tooth of the second connector element to interlock the first and second connector elements. The magnets of the first and second connector elements are arranged to hold the first and second connector elements together when interlocked until manually released.

Yet another embodiment is a method of making any of the anatomic models described above. The method includes forming the first part with the first connector; forming the second part with the second connector; and coupling the first connector to the second connector to form the anatomic model.

In at least some embodiments, forming the first part with the first connector includes coupling the first connector to a remainder of the first part. In at least some embodiments, forming the first part with the first connector includes simultaneously forming the first part with a body portion of the first connector in a single, integrated piece. In at least some embodiments, simultaneously forming includes 3D printing the single, integrated piece including the body portion of the first connector. In at least some embodiments, the method further includes inserting the magnets into the body portion of the first connector. In at least some embodiments, the method further includes adhesively coupling the magnets to the body portion of the first connector. In at least some embodiments, the method further includes disposing a polymer material over the magnets inserted into the body portion of the first connector to retain the magnets within the body portion. In at least some embodiments, simultaneously forming includes molding the single, integrated piece including the body portion of the first connector.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic side view of one embodiment of two connector elements of a connector, according to the invention;

FIG. 2 is a schematic view of the contact surfaces of the two connector elements of FIG. 1, according to the invention;

FIG. 3 is a schematic side view of another embodiment of two connector elements of a connector, according to the invention;

FIG. 4 is a schematic view of the contact surfaces of the two connector elements of FIG. 3, according to the invention; and

FIG. 5 is a schematic side view of two pieces of an anatomic model coupled by a magnetic connector, according to the invention.

### DETAILED DESCRIPTION

The present invention is directed to the area of magnetic connectors. The present invention is also directed to magnetic connectors for use with anatomic models.

Portions of an anatomic model can be held together by magnetic connectors that will generally retain their connection unless deliberately separated and will resist or prevent rotation of the pieces. In at least some embodiments, the anatomic models are printed by a 3D printer and the connectors can be printed (or partially printed) with the anatomic model. For example, the anatomic model can be a model of a vascular system with the system separated into two or more parts with connectors disposed on each of the parts where that part is to be joined with an adjacent part. In at least some embodiments, the connectors are fashioned to conform to the interior surface of the anatomic model with the connector legs extending away from the exterior surface of the anatomic model.

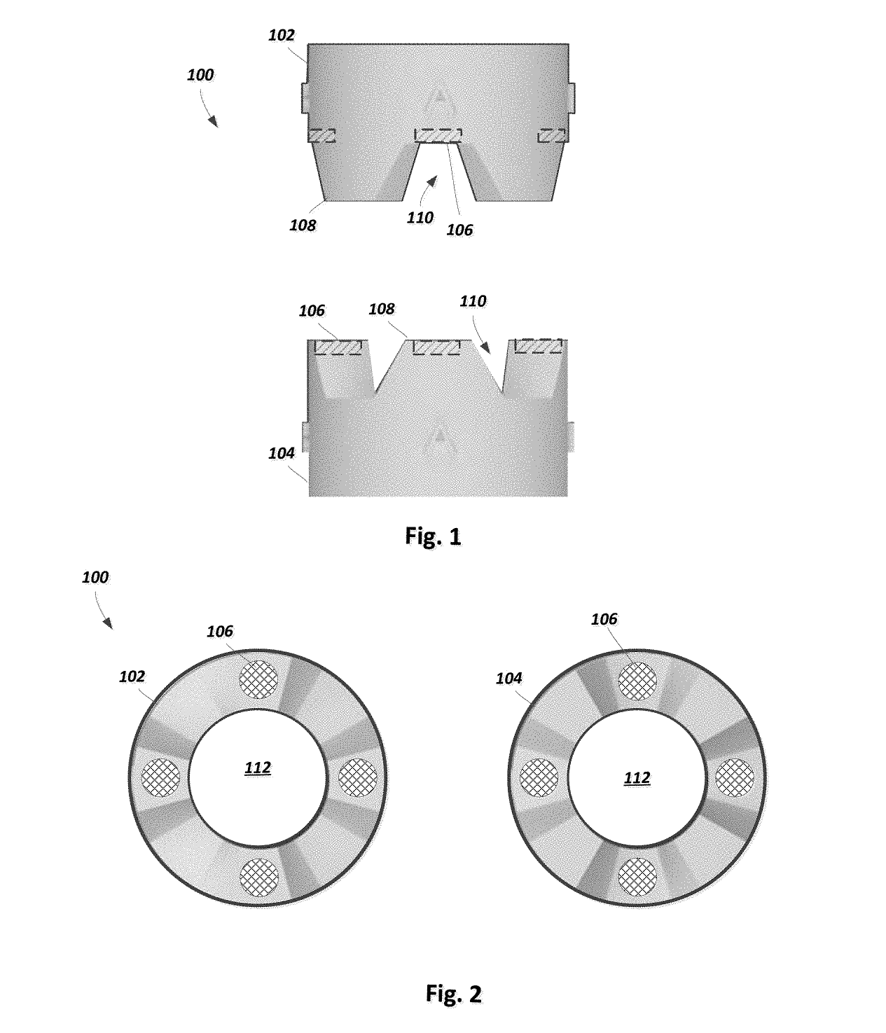

A magnetic connector for an anatomic model includes two opposing connector elements with opposing magnets and interlocking teeth. FIG. 1 illustrates one embodiment of a magnetic connector 100 with two opposing connector elements 102, 104, magnets 106, teeth 108, and indented regions 110 that receive the teeth. FIG. 2 is a view of the two contacting surfaces of the connector elements 102, 104. The connector 100 has an inner lumen 112 that defines an inner diameter and an outer diameter of the connector. In the illustrated embodiment, the cross-sectional shape of the inner lumen 112 is circular and the outer cross-sectional shape of the connector 100 is also circular. It will be understood that the inner lumen can have other cross-sectional shapes including, but not limited to, square, triangular, hexagonal, octagonal, or any other regular or irregular shape. Likewise, it will be understood that the outer cross-sectional shape of the connector can have other cross-sectional shapes including, but not limited to, square, triangular, hexagonal, octagonal, or any other regular or irregular shape. Moreover, it will be understood that the cross-sectional shapes of the inner lumen and the connector can be uniform along a length of the connector or can vary in size or shape. Furthermore, it will be recognized that in some embodiments, the connector will not have an inner lumen or may have multiple inner lumens.

Each connector element 102, 104 has one or more magnets 106. In at least some embodiments, each connector element 102, 104 has two, three, four, five, six, eight, or more magnets. Any suitable magnet can be used. In at least some embodiments, the magnets are rare earth magnets, such as neodymium magnets.

The magnets 106 are arranged such that when two anatomic parts are brought into close proximity, the opposing magnets will attract each other and thus pull the parts together in an arrangement that is anatomically correct. In particular, each pair of magnets from the two opposing connector elements 102, 104 that are intended to attract each other will be placed in the connector elements 102, 104 with opposite poles (i.e., north and south poles) positioned in the connection direction. In a connector element (such as connector element 102) with multiple magnets 106, the magnets of that connector element may all be installed with the same pole positioned in the connection direction or the magnets may have any suitable arrangement of different poles in the connection direction to facilitate a connection between connector elements 102, 104 that is anatomically correct. For example, a connector element with four magnets may have the magnets arranged, going clockwise around the connector element, with north, north, south, south poles in the connection direction. The other connector element would have four magnets arranged in a south, south, north, north arrangement. Any other suitable arrangement of poles can be used.

At least one of the connector elements 102, 104 has at least one tooth 108 and the other connector element(s) has a corresponding indented region 110. Preferably, each of the connector elements 102, 104 has one or more teeth 108 and with corresponding indented regions 110 in the opposing connector element. In the illustrated embodiment of FIGS. 1 and 2, each connector element has four teeth 108 and four indented regions 110. In other embodiments, each connector element can have any number of teeth and indented regions such as, for example, one, two, three, five, six, eight or more teeth or indented regions. In at least some embodiments, each of the connector elements 102, 104 has the same number of teeth 108 and indented regions 110. In other embodiments, the number of teeth 108 and indented regions 110 can be different. In at least some embodiments, as illustrated in FIGS. 1 and 2, the teeth 108 and corresponding indented regions have a larger circumferential length at the outer diameter of the tooth or indented region than at the inner diameter of the tooth or indented regions to resist radial movement.

The connector 100 makes use of interlocking teeth 108 and indented regions 110 that can be gear-like in design. The interlocking teeth create a better connection by guiding the two parts together as their proximity closes. The teeth 108 and indented regions 110 limit translational and rotational motion when the connector elements 102, 104 are engaged. In at least some embodiments, once connected, the teeth 108 and indented regions 110 prevent or resist translational and rotational motion except along a single axis with which the connector elements 102, 104 can be pulled apart by pulling connector elements away from each other. Preferably, the interlocking teeth 108 ensures that the two parts are aligned and oriented correctly as they are mated. Once mated, and in combination with the permanent magnets, the interlocking teeth resist further movement. This makes the connection easier to achieve and more accurate, and facilitates ensuring that the anatomic orientation is correct.

In at least some embodiments, the magnets 106 of one connector element 102 are disposed adjacent the indented regions 110 and the magnets 106 of the other connector element 102 are disposed in the teeth 108. It will be recognized, however, that other arrangements of magnet disposition can be used. For example, one connector element can have magnets disposed in some teeth and adjacent some indented elements with the other connector element have the correspondingly opposite arrangement so that the magnets will mate.

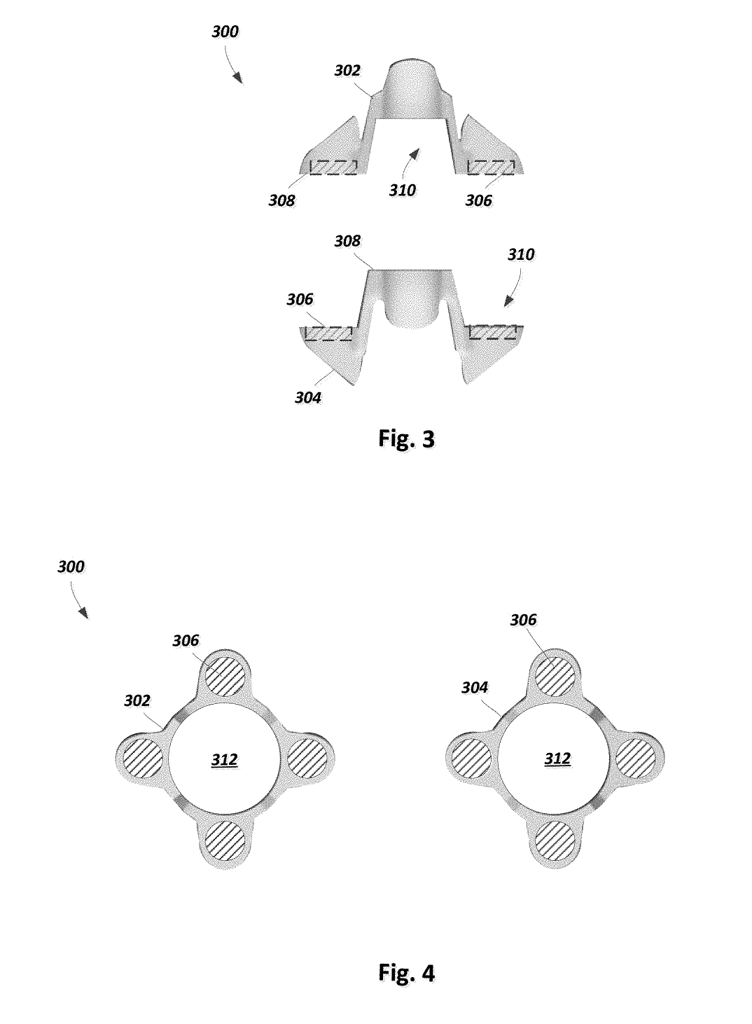

FIG. 3 illustrates another embodiment of a magnetic connector 300 with two opposing connector elements 302, 304, magnets 306, teeth 308, indented regions 310 that receive the teeth, and an inner lumen 312. FIG. 4 is a view of the two contacting surfaces of the connector elements 302, 304. The elements of connector 300 can have the same design considerations and options as connector 100 unless indicated otherwise. In this embodiment, the teeth 308 which contain the magnets 306 extend radially away from the remainder of the connector and can appear as nodes or the like. The illustrated embodiment has four teeth 308 and four magnets 306 for each of the connector elements 302, 304, but other embodiments can have any number of teeth such as, for example, one two, three, five, six, eight, or more teeth.

In at least some embodiments, when used to connect parts of a larger anatomic model, the connector can be formed, fitted, or trimmed to match the natural anatomic surface contour of the model. For example, when used to connect two sections of a blood vessel, the connector can be formed, fitted, or trimmed such that when connected, the internal surface of the blood vessel is not altered. This is particularly useful for medical device testing and training because the device can be deployed across the connector, for example inside a blood vessel, and the presence of the connector will not alter the anatomy or behavior of the device.

In at least some embodiments, the connectors 100, 300 are formed with wells into which the magnets 106, 306 can be placed. In at least some embodiments, the magnets 106, 306 can be attached to the connector elements 102, 104, 302, 304 with adhesive. In at least some embodiments, the wells are sufficiently deep that fluid polymer material can be disposed over the magnets 106, 306 within the wells and then then hardened to form a cap over the magnets 106, 306. In at least some embodiments, this polymer material is the same polymer used to form the connector elements 102, 104, 302, 304, although other polymer materials (including adhesives such as epoxy) can also be used. In yet other embodiments, the material forming the connector elements 102, 104, 302, 304 may be heated to reflow the material over, or at least partially over, the magnets 106, 306.

In at least some embodiments, angles where two interlocking teeth may be prone to breaking or tearing, particularly with soft or flexible materials. Mechanically reinforcing these angles by thickening the material of the connector in these areas can reduce breaking or tearing.

The connectors 100, 300 can be formed by any suitable method. For example, the connectors 100, 300 can be molded and attached to the anatomic models. In other embodiments, the connectors 100, 300 are formed with the anatomic models.

For example, in some embodiments, the anatomic models are formed by 3D printing (or other similar methods). For example, the anatomic model may be formed by converting imaging data (such as Mill, angiographic, ultrasound, fluoroscopic, X-ray, or other imaging data or any combination thereof) into instructions for a 3D printer. The instructions may be further modified to include instructions for also generating one or more connectors 100, 300 in one or more positions along the anatomic model. (It will be understood that the anatomic model may be made in a single printing event or in multiple pieces during multiple printing events.) In at least some embodiments, a user interface may be provided to allow the user to select the position of the connectors along the anatomic model (or along the anatomic data or images). In other embodiments, a processor or algorithm may be used to select positions for the connectors. The anatomic model (or parts of the anatomic model) can then be printed with a body of the connector element formed integrally with the anatomic model. Molding can be alternative to printing. The body of the connector can include all parts of the connector element 102, 104, 302, 304 except the magnets 106, 306 which may be added after the printing (as well as any capping material disposed over the magnets).

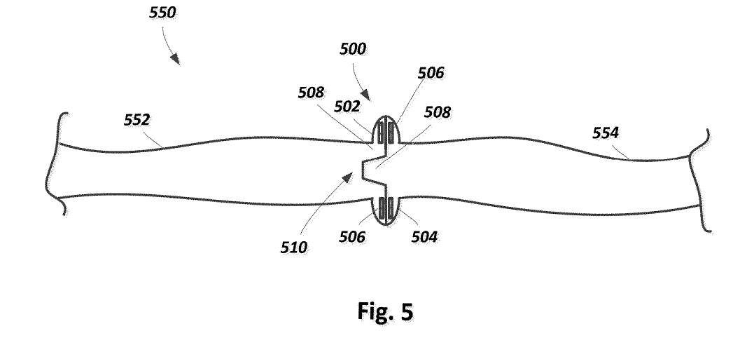

FIG. 5 illustrate one embodiment of an anatomic model 550 (in this case, a model of a part of a vascular system) with two parts 552, 554; each part having a connector element 502, 504, respectively, forming the connector 500 and integrally formed with the part of the anatomic model to which it is attached. Each of the connector elements 502, 504 of the illustrated connector 504 includes magnets 506, two teeth 508, and two indented regions 510. The inner lumen of the connector 504 is shaped to correspond to the corresponding region of the anatomic model where the connector resides. In some embodiments, the parts 552, 554 (and corresponding connector elements 502, 504) can be made of the same material. In other embodiments, the parts 552,554 (and corresponding connector elements 502, 504) can be made of different materials. For example, the material of one part can be rigid and the material of another part may be more flexible. Such an arrangement may represent anatomic differences or be made for any other suitable reason.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. An anatomic model, comprising:
a first part with a first connector element disposed at one end of the first part, the first connector element comprising at least one tooth, at least one indented region, and a plurality of magnets disposed within the tooth or adjacent the indented region; and
a second part with a second connector element disposed at one end of the second part, the second connector element comprising at least one tooth, at least one indented region, and a plurality of magnets disposed within the tooth or adjacent the indented region,
wherein the at least one indented region of the second connector element is configured and arranged to receive the at least one tooth of the first connector element and the at least one indented region of the first connector element is configured and arranged to receive the at least one tooth of the second connector element to interlock the first and second connector elements, and wherein the magnets of the first and second connector elements are arranged to hold the first and second connector elements together when interlocked until manually released.

2. The anatomic model of claim 1, wherein the first connector element comprises a plurality of the teeth and a plurality of the indented regions and the second connector element comprises a plurality of the teeth and a plurality of the indented regions.

3. The anatomic model of claim 2, wherein the magnets of the first connector element are disposed within the teeth of the first connector element.

4. The anatomic model of claim 3, wherein the magnets of the second connector element are disposed adjacent the indented regions of the second connector element.

5. The anatomic model of claim 2, wherein each of the teeth of the first and second connector elements has a longer outer circumferential length than inner circumferential length to resist translational or radial movement of the first and second connector elements relative to each other when engaged.

6. The anatomic model of claim 1, wherein the anatomic model represents a portion of a vascular system and contains a lumen corresponding to a vascular lumen.

7. The anatomic model of claim 6, wherein each of the first and second connectors defines an inner lumen extending therethrough.

8. The anatomic model of claim 7, wherein the inner lumens of the first and second connectors have a shape corresponding to the vascular lumen at a position where the first and second connector elements are placed in the anatomic model.

9. The anatomic model of claim 1, wherein the first and second connector elements are integrally formed with the first and second parts, respectively.

10. The anatomic model of claim 1, wherein the first and second connector elements, other than the magnets, are formed of a same material as a remainder of the first and second parts.

11. The anatomic model of claim 1, wherein each of the magnets is disposed in a well within the respective first or second connector element and covered with a polymeric material.

12. The anatomic model of claim 1, wherein the first part and the first connector element, except for the magnets, are made of a first material and the second part and the second connector element are made of a second material different from the first material.

13. A method of making the anatomic model of claim 1, the method comprising:
forming the first part with the first connector;
forming the second part with the second connector; and
coupling the first connector to the second connector to form the anatomic model.

14. The method of claim 13, wherein forming the first part with the first connector comprises coupling the first connector to a remainder of the first part.

15. The method of claim 13, wherein forming the first part with the first connector comprises simultaneously forming the first part with a body portion of the first connector in a single, integrated piece.

16. The method of claim 15, wherein simultaneously forming comprises 3D printing the single, integrated piece including the body portion of the first connector.

17. The method of claim 16, further comprising inserting the magnets into the body portion of the first connector.

18. The method of claim 17, further comprising adhesively coupling the magnets to the body portion of the first connector.

19. The method of claim 17, further comprising disposing a polymer material over the magnets inserted into the body portion of the first connector to retain the magnets within the body portion.

20. The method of claim 13, wherein simultaneously forming comprises molding the single, integrated piece including the body portion of the first connector.
